(19) United States
(12) Patent Application Publication
(10) Pub. No.: US 2017/0123615 A1
(43) Pub. Date: May 4, 2017

(54) METHOD AND ELECTRONIC DEVICE FOR PROHIBITING NOTIFICATIONS IN APPLICATION WINDOW

(71) Applicants: Le Holdings (Beijing) Co., Ltd., Beijing (CN); Lemobile Information Technology (Beijing) Co., Ltd., Beijing (CN)

(72) Inventor: Junkai YIN, Beijing (CN)

(21) Appl. No.: 15/246,539

(22) Filed: Aug. 25, 2016

Related U.S. Application Data
(63) Continuation of application No. PCT/CN2016/086082, filed on Jun. 16, 2016.

(30) Foreign Application Priority Data
Oct. 30, 2015 (CN) 2015107328986

(51) Int. Cl. G06F 3/0484; G06F 9/54; G06F 3/14

(52) U.S. Cl. CPC G06F 3/0484; G06F 3/14; G06F 9/542

(57) ABSTRACT

Disclosed are a method and electronic device for prohibiting notifications in an application window, wherein the method comprises: when an application window is switched, updating window information of an application, the window information comprising one or more of display information, setting information and layout information of the application; judging whether the window information comprises a notification prohibition mark, the notification prohibition mark being a mark set according to a notification type and used for prohibiting notifications of the corresponding type; and if the window information comprises the notification prohibition mark, then when a new notification is received, prohibiting the display of the new notification according to the notification prohibition mark, and adding the new notification into a notification list. By adding a specific notification prohibition mark into the window information of the application, the effect of prohibiting the display of banner notifications in a specific window is achieved.

### CROSS REFERENCE TO RELATED APPLICATIONS

This application is a continuation of International Application No. PCT/CN2016/086082, filed on Jun. 16, 2016, which is based upon and claims priority to Chinese Patent Application No. 2015107328986, filed on Oct. 30, 2015, the entire contents of which are incorporated herein by reference.

### TECHNICAL FIELD

The present application relates to the technical field of message notifications in the field of communication, and more particularly to a method and electronic device for prohibiting notifications in an application window.

### BACKGROUND

With the development of smart phones, a mobile phone has become more than just a communication tool for making a call. A variety of applications in application markets cover all aspects of our lives and are installed in the mobile phone of each person to facilitate the basic necessities of life. However, notifications and messages sent out by each application often disturb the user, and especially, the banner notifications propping up from the applications when the user watches videos or plays games will cause disturbances to the user.

### SUMMARY

In order to overcome the defect in the prior art that notification messages will cause disturbances to users' normal use of applications, according to one aspect of the present disclosure, the present disclosure provides a method for prohibiting notifications in an application window.

A method for prohibiting notifications in an application window provided in the embodiment of the present disclosure includes:
when an application window is switched, updating window information of an application, the window information comprising one or more of display information, setting information and layout information of the application;
judging whether the window information includes a notification prohibition mark, the notification prohibition mark being a mark set according to a notification type and used for prohibiting a notification of a corresponding type; and
if the window information includes the notification prohibition mark, then when a new notification is received, prohibiting the display of the new notification according to the notification prohibition mark, and adding the new notification into a notification list.

Based on the same inventive concept, the embodiment of the present disclosure also provides an electronic device, including: at least one processor; and a memory communicably connected with the at least one processor for storing instructions executable by the at least one processor, wherein execution of the instructions by the at least one processor causes the at least one processor to: when an application window is switched, updating window information of an application, the window information comprising one or more of display information, setting information and layout information of the application; judging whether the window information includes a notification prohibition mark, the notification prohibition mark being a mark set according to a notification type and used for prohibiting notifications of the corresponding type; and if the window information includes the notification prohibition mark, then when a new notification is received, prohibiting the display of the new notification according to the notification prohibition mark, and adding the new notification into a notification list.

Based on the same inventive concept, the embodiment of the present disclosure also provides a non-transitory computer-readable storage medium storing executable instructions that, when executed by an electronic device, cause the electronic device to: when an application window is switched, updating window information of an application, the window information comprising one or more of display information, setting information and layout information of the application; judging whether the window information includes a notification prohibition mark, the notification prohibition mark being a mark set according to a notification type and used for prohibiting notifications of the corresponding type; and if the window information includes the notification prohibition mark, then when a new notification is received, prohibiting the display of the new notification according to the notification prohibition mark, and adding the new notification into a notification list.

The technical solution of the present disclosure will be further described below in details through the accompanying drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of the method for prohibiting notifications in an application window in the embodiment of the present disclosure;

FIG. 2 is a flow diagram of the method for prohibiting notifications in an application window in Embodiment 1 of the present disclosure;

FIG. 3 is a first structure diagram of the device for prohibiting notifications in an application window in the embodiment of the present disclosure;

FIG. 4 is a second structure diagram of the electronic device for prohibiting notifications in an application window in the embodiment of the present disclosure;

FIG. 5 is a third structure diagram of the electronic device for prohibiting notifications in an application window in the embodiment of the present disclosure;

FIG. 6 is a fourth structure diagram of the electronic device for prohibiting notifications in an application window in the embodiment of the present disclosure;

FIG. 7 is a fifth structure diagram of the electronic device for prohibiting notifications in an application window in the embodiment of the present disclosure

### DETAILED DESCRIPTION

The specific embodiments of the present disclosure will be described below in details with reference to the accompanying drawings, but it will be appreciated that the protection scope of the present disclosure is not limited by the specific embodiments.

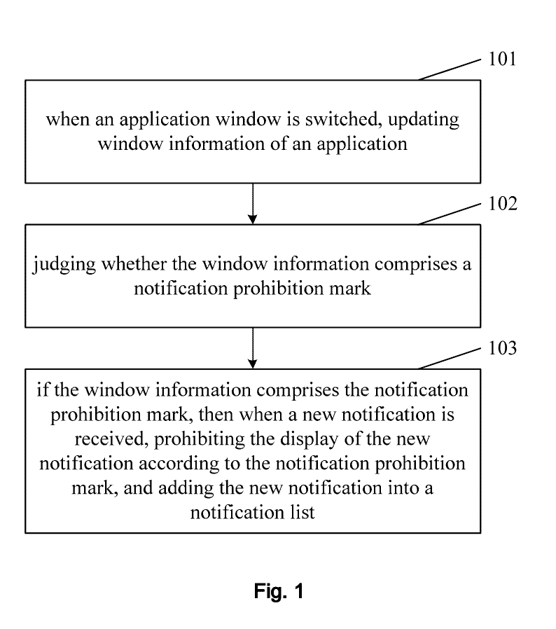

According to the embodiment of the present disclosure, a method for prohibiting notifications in an application window is provided. FIG. 1 is a flow diagram of the method, and the method specifically includes steps 101-103:

S101: when an application window is switched, updating window information of an application, the window information comprising one or more of display information, setting information and layout information of the application.

In the embodiment of the present disclosure, the application window is an interface for operating the application, the operation of switching the application window can be switching from one application to another, or opening a new application; and regardless of the switching operation, the window information of the application may change, and the window information of the application needs to updated. The window information includes one or more of display information, setting information and layout information of the application, wherein the display information is information displayed to the interface, the setting information includes related settings of the application that may include a notification prohibition mark, and the layout information is the interface layout of the application.

S102: judging whether the window information includes a notification prohibition mark, the notification prohibition mark being a mark set according to a notification type and used for prohibiting notifications of the corresponding type.

In the embodiment of the present disclosure, the display of a notification message is prohibited by setting a notification prohibition mark. Specifically, the notification prohibition mark is a mark set according to a notification type. The notification type specifically includes one or more of banner notification, full screen notification, ringtone notification, vibration notification and marquee notification. For example, the notification prohibition mark prohibits banner notification and ringtone notification, and when other notification messages need to be displayed, these notification messages are prohibited from being displayed in the form of the banner notification and the ringtone notification; and if the notification messages are set to be displayed in the form of a banner, then under the current application window, the notification messages are completely not displayed.

S103: if the window information includes the notification prohibition mark, then when a new notification is received, prohibiting the display of the new notification according to the notification prohibition mark, and adding the new notification into a notification list.

Specifically, the display of the new notification is prohibited according to the notification type prohibited by the notification prohibition mark. As described above, if the notification prohibition mark prohibits banner notification and ringtone notification, then when the new notification needs to be displayed, the new notification is prohibited from being displayed in the form of the banner notification and the ringtone notification; and if the new notification is set to be displayed in the form of a banner, then under the current application window, the notification message is completely not displayed.

In a possible embodiment, if the window information includes the notification prohibition mark, the method further includes: transmitting the window information or the notification prohibition mark to a system layer, and saving the window information or the notification prohibition mark to generate a corresponding notification strategy. That is to say, the notification prohibition mark is transmitted to the system layer and then saved so as to generate a notification strategy; and the notification strategy is a strategy for displaying a new notification. When the new notification is received, the new notification can be displayed accordingly according to the notification strategy.

According to the method for prohibiting notifications in an application window provided in the embodiment of the present disclosure, a specific notification prohibition mark is added into window information of an application and is added into notification display conditions, and an existing notification message display strategy is used, so that the effect of prohibiting the display of banner notifications in a specific window is achieved, and a user is prevented from being always disturbed by the banner notifications in a specific scene.

In a possible embodiment, the method further includes steps A1-A2:
SA1, judging whether the new notification includes precedence information, the precedence information comprising a notification type of a preferentially displayed notification message; and
SA2, when the new notification includes the precedence information, displaying the new notification according to the notification type of the preferentially displayed notification message in the precedence information, and adding the new notification into a notification list.

In the embodiment of the present disclosure, the new notification may set the notification message to be displayed preferentially through the precedence information. The notification type of the preferentially displayed notification message may also comprise one or more of banner notification, full screen notification, ringtone notification, vibration notification and marquee notification. The notification type of the preferentially displayed notification message is generally set as full screen notification only. For example, the window information of the current application includes a notification prohibition mark and the notification prohibition mark is for prohibiting banner notifications, and if a new notification of a certain application (e.g. telephone) includes the precedence information and the precedence information is the mode of full screen display, then even though the current application has a notification prohibition setting, the notification message of this application (e.g. telephone) is still displayed later in a full screen mode because the priority of another application (e.g. telephone) is higher. By setting a priority message, the notification message of an important application is prevented from being prohibited, thereby avoiding such a situation where the user cannot notice an important notification in time.

In one embodiment, when a new notification is received, the method further includes: judging whether the new notification exists in a notification list; when the new notification does not exist in the notification list, continuously performing the step of prohibiting the display of the new notification; and if the new notification already exists in the notification list, displaying the new notification message in an existing display mode.

Hereinafter, the flow diagram of the method will be introduced in details through an embodiment.

### Embodiment 1

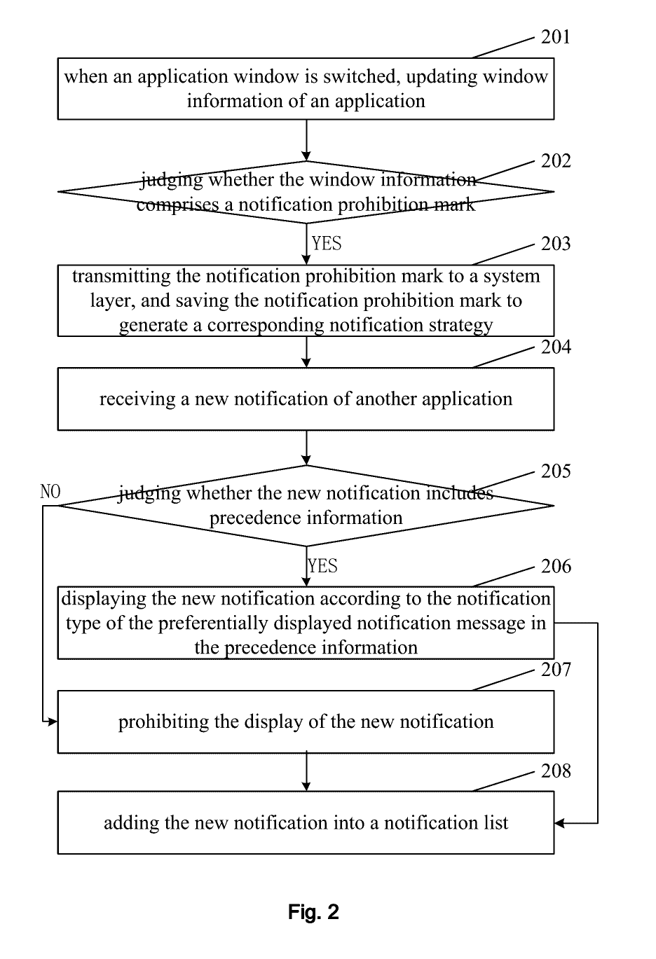

In Embodiment 1, when a new notification is received, whether precedence information is included is judged, and then corresponding operations are continued. Specifically, as shown in FIG. 2, the method includes steps 201-208:
S201: when an application window is switched, updating window information of an application, wherein the window information includes one or more of display information, setting information and layout information of the application;
S202: judging whether the window information includes a notification prohibition mark, and when the window information includes the notification prohibition mark, proceeding to S203, otherwise, displaying a notification message in a normal way.

In Embodiment 1, the notification prohibition mark is used for prohibiting the notification message from being displayed in the form of a banner. When the window information does not include the notification prohibition mark, a corresponding notification message can be displayed according to an existing notification strategy.

S203: transmitting the notification prohibition mark to a system layer, and saving the notification prohibition mark to generate a corresponding notification strategy, wherein cross-process calling is used for transmitting the notification prohibition mark. Specifically, when the window information is updated, updateSystemUiVisibilityLw( ) is called to acquire SystemUI related window information. Cross-process calling is achieved by use of AIDL, an updateSystemUIWindowFlag( ) interface is added, and the SystemUI related window information is transmitted through StatusBarManagerService.

S204: receiving a new notification of another application.

S205: judging whether the new notification includes precedence information, and when the new notification includes the precedence information, proceeding to S206, otherwise, proceeding to S207.

S206: displaying the new notification according to the notification type of the preferentially displayed notification message in the precedence information, and proceeding to S208.

In Embodiment 1, display of the precedence information in a full screen mode is taken as an example, that is to say, if the new notification includes the precedence information, the new notification is displayed in a full screen mode.

S207: prohibiting the display of the new notification, and proceeding to S208.

S208: adding the new notification into a notification list.

In Embodiment 1, by taking the window information and the precedence information of the new notification as joint determination conditions, a notification display strategy is determined, and if the current application window prohibits a pop-up banner notification, then this notification is displayed in a full screen mode (when there is precedence information), or the notification is added into the notification list in a notification bar (when there is no precedence information), thereby avoiding such a situation where a user omits important notifications.

The flow of the method for prohibiting notifications in an application window is introduced in details hereinabove, the method can also be implemented through a corresponding device, and the structure and functions of the device will be introduced in details below.

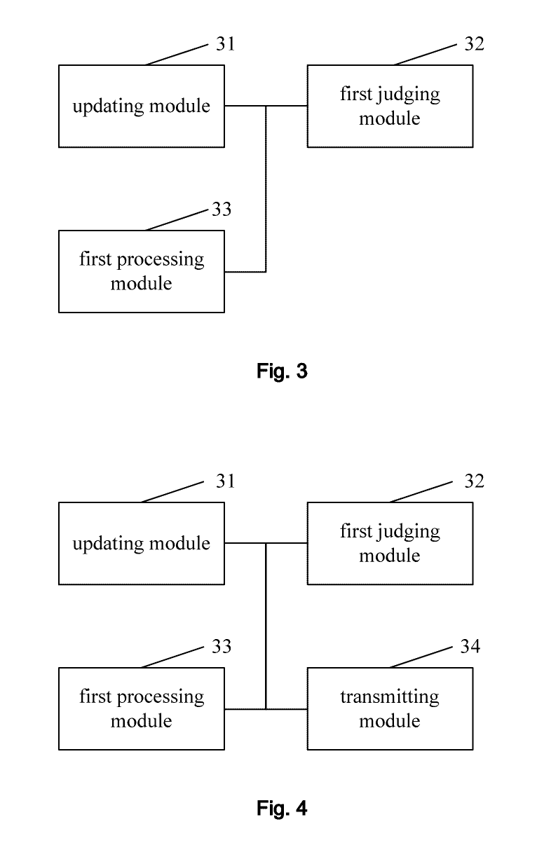

According to the embodiment of the present disclosure, a electronic device for prohibiting notifications in an application window is provided. As shown in FIG. 3, the device includes:
an updating module 31, which is used for updating, when an application window is switched, window information of an application, the window information comprising one or more of display information, setting information and layout information of the application;
a first judging module 32, which is used for judging whether the window information includes a notification prohibition mark, the notification prohibition mark is a mark set according to a notification type and used for prohibiting notifications of the corresponding type; and
a first processing module 33, which is used for, if the window information includes the notification prohibition mark, then when a new notification is received, prohibiting the display of the new notification according to the notification prohibition mark, and adding the new notification into a notification list.

In a possible embodiment, if the window information includes the notification prohibition mark, as shown in FIG. 4, the device further includes:
a transmitting module 34, which is used for transmitting the window information or the notification prohibition mark to a system layer, and saving the window information or the notification prohibition mark to generate a corresponding notification strategy.

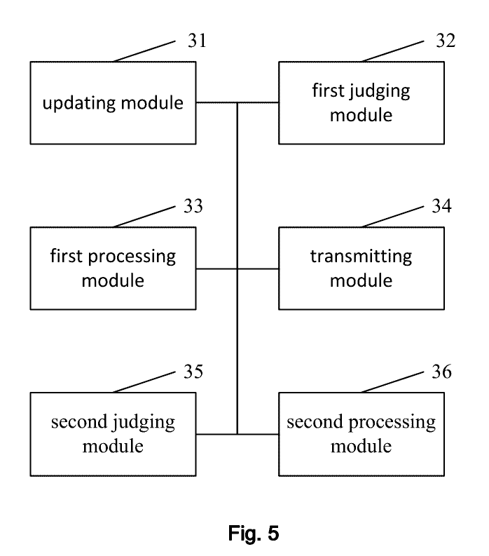

In a possible embodiment, as shown in FIG. 5, the device further includes:
a second judging module 35, which is used for judging whether the new notification includes precedence information, the precedence information comprising a notification type of a preferentially displayed notification message; and
a second processing module 36, which is used for displaying, when the new notification includes the precedence information, the new notification according to the notification type of the preferentially displayed notification message in the precedence information, and adding the new notification into a notification list.

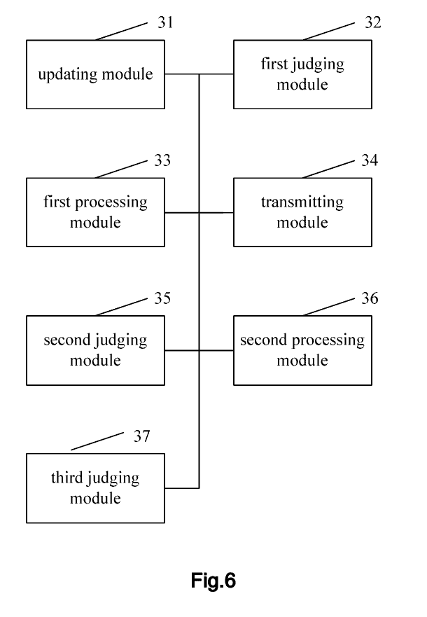

In a possible embodiment, as shown in FIG. 6, the device further includes:
a third judging module 37, which is used for judging, when a new notification is received, whether the new notification exists in a notification list; and when the new notification does not exist in the notification list, continuously performing the step of prohibiting the display of the new notification.

In a possible embodiment, the notification type includes one or more of banner notification, full screen notification, ringtone notification, vibration notification and marquee notification.

According to the method and electronic device for prohibiting notifications in an application window provided in the embodiment of the present disclosure, a specific notification prohibition mark is added into window information of an application and is added into notification display conditions, and an existing notification message display strategy is used, so that the effect of prohibiting the display of banner notifications in a specific window is achieved, and a user is prevented from being always disturbed by the banner notifications in a specific scene. By setting a priority message, the notification messages of an important application is prevented from being prohibited, thereby avoiding such a situation where the user cannot notice an important notification in time.

### Embodiment 2

The embodiment of the present disclosure provides a non-transitory computer-readable storage medium storing executable instructions that, when executed by an electronic device, cause the electronic device to execute the processing method in the case of any method embodiment mentioned above.

### Embodiment 3

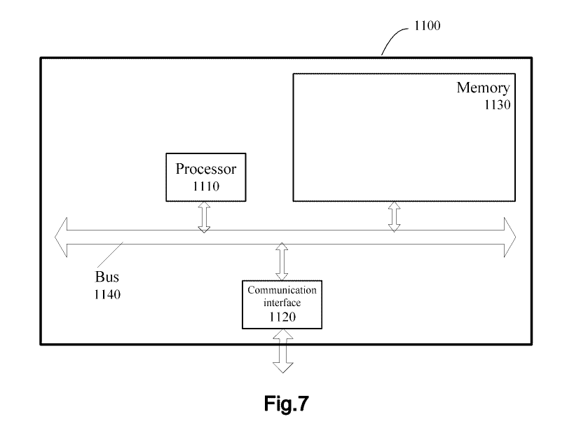

FIG. 7 illustrates a block diagram of a structure of an electronic device for prohibiting notifications in an application window. in another embodiment of the present invention. The network device 1100 may be a host server, a personal computer (PC), or a portable computer or terminal and the like with computing power. The specific embodiments of the present invention do not limit concrete implementation of computing nodes.

The network device 1100 includes a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element includes, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the present invention.

The memory 1130 is used for storing files. The memory 1130 may comprise a high-speed RAM memory, and may also comprise a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned program may be program codes comprising computer operating instructions. Specifically, the program can be used to execute the processing method in the case of any method embodiment mentioned above.

The present disclosure may have various specific embodiments in different forms, the technical solution of the present disclosure is illustrated above by taking FIG. 1 to FIG. 6 as examples in combination with the accompanying drawings, and this does not mean that the specific examples applied by the present disclosure can only be limited in specific flows or embodiment structures. It will be appreciated by those of ordinary skill in the art that the specific embodiments provided hereinabove are just some examples of a variety of preferred usages, and any embodiment embodying the claims of the present disclosure shall be within the protection scope claimed by the technical solution of the present disclosure.

Finally, it should be noted that only the preferred embodiments of the present disclosure are described above, and are not intended to limit the present disclosure. Although the present disclosure has been described in details with reference to the foregoing embodiments, those skilled in the part still can modify the technical solution stated in the various foregoing embodiments, or equivalently replace part of the technical features therein. Any modification, equivalent replacement, improvement, etc. made within the spirit and principle of the present disclosure shall be included within the protection scope of the present disclosure.

What is claimed is:

1. A method for prohibiting notifications in an application window, executed by an electronic device, comprising:
when an application window is switched, updating window information of an application, the window information comprising one or more of display information, setting information and layout information of the application;
judging whether the window information comprises a notification prohibition mark, the notification prohibition mark being a mark set according to a notification type and used for prohibiting notifications of the corresponding type; and
if the window information comprises the notification prohibition mark, then when a new notification is received, prohibiting the display of the new notification according to the notification prohibition mark, and adding the new notification into a notification list.

2. The method according to claim 1, wherein, if the window information comprises the notification prohibition mark, the method further comprises:
transmitting the window information or the notification prohibition mark to a system layer, and saving the window information or the notification prohibition mark to generate a corresponding notification strategy.

3. The method according to claim 1, further comprising:
judging whether the new notification includes precedence information, the precedence information comprising a notification type of a preferentially displayed notification message; and
when the new notification includes the precedence information, displaying the new notification according to the notification type of the preferentially displayed notification message in the precedence information, and adding the new notification into a notification list.

4. The method according to claim 3, wherein, when a new notification is received, the method further comprises:
judging whether the new notification exists in the notification list; and when the new notification does not exist in the notification list, continuously performing the step of prohibiting the display of the new notification.

5. The method according to claim 1, wherein, the notification type comprises one or more of banner notification, full screen notification, ringtone notification, vibration notification and marquee notification.

6. An electronic device, comprising:
at least one processor; and
a memory communicably connected with the at least one processor for storing instructions executable by the at least one processor, wherein execution of the instructions by the at least one processor causes the at least one processor to:
when an application window is switched, updating window information of an application, the window information comprising one or more of display information, setting information and layout information of the application;
judging whether the window information comprises a notification prohibition mark, the notification prohibition mark being a mark set according to a notification type and used for prohibiting notifications of the corresponding type; and
if the window information comprises the notification prohibition mark, then when a new notification is received, prohibiting the display of the new notification according to the notification prohibition mark, and adding the new notification into a notification list.

7. The electronic device according to claim 6, wherein, if the window information comprises the notification prohibition mark, execution of the instructions by the at least one processor causes the at least one processor to:
transmitting the window information or the notification prohibition mark to a system layer, and saving the window information or the notification prohibition mark to generate a corresponding notification strategy.

8. The electronic device according to claim 6, wherein execution of the instructions by the at least one processor causes the at least one processor to:
judging whether the new notification includes precedence information, the precedence information comprising a notification type of a preferentially displayed notification message; and
when the new notification includes the precedence information, displaying the new notification according to the notification type of the preferentially displayed notification message in the precedence information, and adding the new notification into a notification list.

9. The electronic device according to claim 8, wherein, when a new notification is received, execution of the instructions by the at least one processor causes the at least one processor to:
judging whether the new notification exists in the notification list; and when the new notification does not exist in the notification list, continuously performing the step of prohibiting the display of the new notification.

10. The electronic device according to claim 6, wherein, the notification type comprises one or more of banner notification, full screen notification, ringtone notification, vibration notification and marquee notification.

11. A non-transitory computer-readable storage medium storing executable instructions that, when executed by an electronic device, cause the electronic device to:
when an application window is switched, updating window information of an application, the window information comprising one or more of display information, setting information and layout information of the application;
judging whether the window information comprises a notification prohibition mark, the notification prohibition mark being a mark set according to a notification type and used for prohibiting notifications of the corresponding type; and
if the window information comprises the notification prohibition mark, then when a new notification is received, prohibiting the display of the new notification according to the notification prohibition mark, and adding the new notification into a notification list.

12. The non-transitory computer-readable storage medium according to claim 11, wherein the instructions is set to:
if the window information comprises the notification prohibition mark, transmitting the window information or the notification prohibition mark to a system layer, and saving the window information or the notification prohibition mark to generate a corresponding notification strategy.

13. The non-transitory computer-readable storage medium according to claim 11, wherein the instructions is set to:
judging whether the new notification includes precedence information, the precedence information comprising a notification type of a preferentially displayed notification message; and
when the new notification includes the precedence information, displaying the new notification according to the notification type of the preferentially displayed notification message in the precedence information, and adding the new notification into a notification list.

14. The non-transitory computer-readable storage medium according to claim 13, wherein the instructions is set to:
when a new notification is received, judging whether the new notification exists in the notification list; and when the new notification does not exist in the notification list, continuously performing the step of prohibiting the display of the new notification.

15. The non-transitory computer-readable storage medium according to claim 11, wherein, the notification type comprises one or more of banner notification, full screen notification, ringtone notification, vibration notification and marquee notification.
